(19) United States
(12) Patent Application Publication
(10) Pub. No.: US 2018/0039941 A1
(43) Pub. Date: Feb. 8, 2018

(54) SYSTEM AND METHOD FOR TRACKING A CONTAINER

(71) Applicant: BriefTrace Ltd., Herzliya (IL)

(72) Inventors: EYAL KAMIR, NETANYA (IL); ROTEM FARTOOK, DALLAS, TX (US)

(21) Appl. No.: 15/227,125

(22) Filed: Aug. 3, 2016

(51) Int. Cl. G06Q 10/08; H04W 4/02

(52) U.S. Cl. CPC G06Q 10/0833; H04W 4/023

(57) ABSTRACT

A system and method for tracking a container may include a memory; a communication unit; a location unit adapted to determine a location of the container, a power source; and a controller configured to: use the communication unit to report a location of the container to a server. A container may include sensors for sensing at least one of: a temperature, a motion, a pressure, a humidity, an acceleration, a velocity, an opening of the container and a presence of specific objects in the container and a controller included in the container may be adapted to autonomously send a message to the server based on input from the sensors.

### CROSS-REFERENCE TO RELATED APPLICATIONS

This application claims the benefit of U.S. Provisional Patent Application No. 62/292,325, entitled “System and method for envelope “smart envelope” (“Briefca” Diamond)”, filed on Feb. 7, 2016, which is incorporated in its entirety herein by reference.

### FIELD OF THE INVENTION

The present invention relates generally to tracking a container. More specifically, the present invention relates to tracking an envelope carrying valuable items.

### BACKGROUND OF THE INVENTION

Tracking devices and systems are known in the art, for example, vehicles may be tracked using global positioning system (GPS) systems. However, known systems and methods are unsuitable for tracking small objects. Moreover, known systems and methods cannot track and/or monitor various aspects related to small objects or containers, e.g., an envelope.

For example, there currently exists no system or method for tracking, over a long time period, a small container shipped from a merchant to a customer. For example, known systems and methods cannot track or monitor an envelope used for shipping precious stones (e.g., diamonds), e.g., a brifka or briftje as known in the art. Accordingly, when sending diamonds or other valuable stones or objects using an envelope, or any other small container, a sender cannot know, continuously and/or in real-time, what is happening with the envelope or container, e.g., where the envelope is, whether or not the envelope is moving or is stationary and so on.

### SUMMARY OF THE INVENTION

A system and method for tracking a container may include a memory; a communication unit; a location unit adapted to determine a location of the container; a power source; and a controller configured to: use the communication unit to report a location of the container to a server. The controller may be adapted to autonomously use the communication unit to connect to a network and send, over the network, a message to the server.

The container may include sensors for sensing at least one of: a temperature, a motion, a pressure, a humidity, an acceleration, a velocity, an opening of the container and a presence of specific objects in the container and the controller may be adapted to autonomously send a message to the server based on input from the sensors. A controller included in a first container may be adapted to: communicate with a controller in a second container, determine a distance of the second container from the first container, and if the distance is above a threshold then report to a server.

A server may be adapted to track a group of containers and generate an alarm if at least one container is separated from the group. A controller included in the container may be adapted to detect and report at least one of: an opening of the container and a replacement of an object in the container. A controller included in the container may be adapted to shutdown or activate a component included in the container based on at least one of: a state, a context, a status and a condition of the container. A controller included in the container may be adapted to send information to the server based on at least one of: a state, a context, a status and a condition of the container.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of an exemplary computing device according to illustrative embodiments of the present invention;

FIG. 2 is an overview of a system according to illustrative embodiments of the present invention; and

FIG. 3 shows a flowchart of a method according to illustrative embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

An embodiment may enable tracking and monitoring a container. In some embodiments, a system included in a container includes a plurality of sensors and other components, units or modules that may enable sensing and/or determining various aspects related to the container. In some embodiments, components of a system included in a container may communicate with and/or be controlled by, a remote computing device or server, e.g., using the Internet or another network.

As known in the art, a briftje, brifca or brifka is a special envelop (folded in a special way) used for shipping diamonds. Although for the sake of clarity and simplicity, a brifka carrying diamonds is mainly referred to herein, it will be understood that that embodiments of the invention may be, or may include, any container that carries or includes any objects or items. For example, any box or envelop that includes jewelry, medicine, papers or other objects or items may include system 100 and may be tracked, monitored and managed or otherwise behave as described herein with reference to a brifka.

In some embodiments, a system included in a brifka may provide (using communication components) details such as where the brifka is, whether or not the brifka: is moving; has reached its destination; was opened; and contains a known or identified set of known objects (e.g., whether or not the brifka contains the diamonds placed in the brifka by the sender).

Various aspects related to a brifka (or another container or envelope) may be monitored and/or reported, e.g., using sensors and/or another circuitry included or installed in a brifka. For example, a board that includes sensors and other circuitry may be embedded in a brifka and may measure, calculate or determine a temperature, pressure, humidity, location, acceleration, velocity, movement, weather, elevation and other environmental aspects in or near the brifka. Sensors included in a board or chip embedded in a brifka may sense an opening of the brifka, a replacement of a set of known or identified diamonds in the brifka with another set. Sensors embedded in a brifka may identify fingerprint or other bio-metric data.

A board embedded in a brifka may use its communication components in order to report measured and determined information and/or receive commands and the board may perform various actions based on measured and determined information and based on commands, requests or other data received from a network.

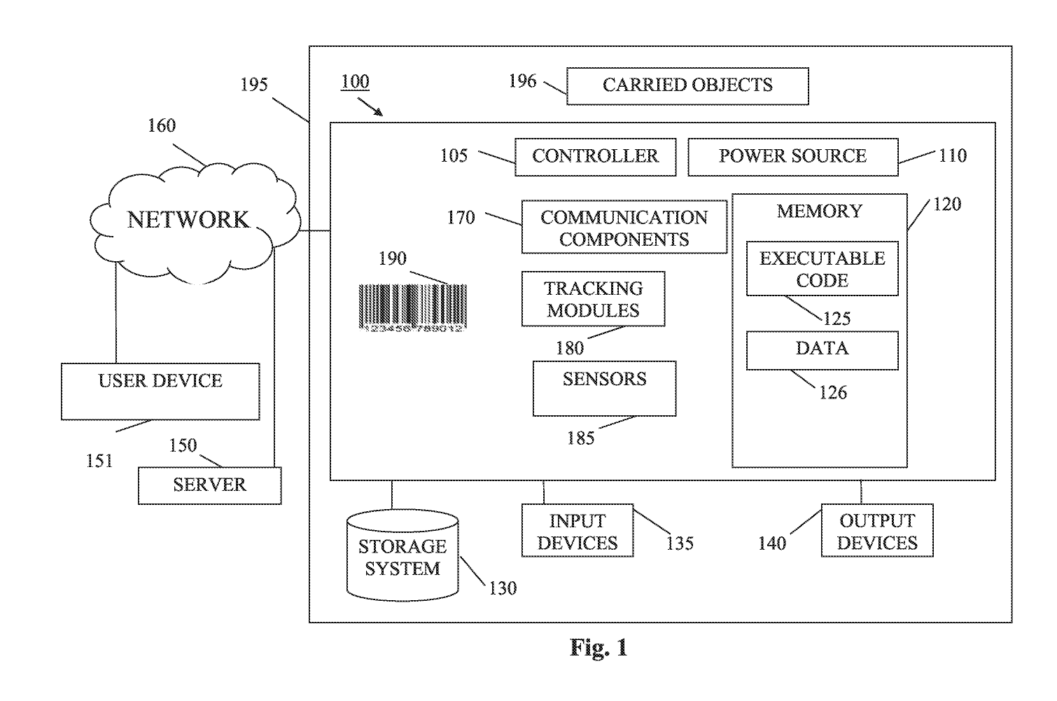

Reference is made to FIG. 1, showing a high level block diagram of an exemplary system 100 according to some embodiments of the present invention. As shown, a system 100 may be included, or installed, in a container 195 that includes or carries carried objects 196. For example, system 100 may be included in an envelope (container 195) used for shipping diamonds (carried objects 196), e.g., container 195 may be a brifka as known in the art.

As shown, system 100 may include a controller 105, a memory 120, executable code 125 and a data object or segment 126 included in memory 120, a storage system 130, input devices 135 and output devices 140. As further shown, system 100 may include communication components 170, tracking devices 180, sensors 185 and a power source 110. As shown, system 100 may include a barcode or another identifier 190. As further shown, system 100 may be connected to a network 160. As shown, a user device 151 and a server 150 may be connected to network 160.

Controller 105 may be for example, a central processing unit processor (CPU), a chip or any suitable computing or computational device. For example, in order to achieve low foot print and/or reduce power consumption, controller 105 may be, or may include, a small application-specific integrated circuit (ASIC) and/or a field-programmable gate array (FPGA) chip.

Communication components 170 may include units or modules for communicating over networks such as Bluetooth, Global System for Mobile communication (GSM), Bluetooth Low Energy (BLE), Sub 1-GHz Short Distance Wireless Radio, WiFi, personal area network (PAN) or any other network as known in the art. Accordingly, controller 105 (or any other unit in system 100) may freely communicate with remote computing devices, e.g., over the internet using any wired or wireless technology. Controller 105 in a first system 100 may communicate with a controller 105 in a second system 100, e.g., using a PAN module as described. Accordingly, system 100 may be adapted to communicate, with any entity, over any wireless or wired network, e.g., a cellular communication network as known in the art. Communication components 170 may include a radio frequency (RF) device or component as known in the art, e.g., a Radio-frequency identification (RFID) device, system, module or component.

Communication components 170 may include a subscriber identity module or subscriber identification module (SIM) card as known in the art, accordingly, controller 105 may communicate with a telephone as known in the art. For example, based on a condition or event, controller 105 may call a sender and/or receiver and play a recording stored in memory 120 and/or use text to speech (TIS) technology in order to verbally provide the sender or receiver with information. For example, upon determining or detecting that brifka 195 was opened, controller 105 may (using a number stored in memory 120), call the sender, play a recording that informs the sender that brifka was opened, and, using TTS to convert data stored in memory 120 to human voice, provide the sender with any information recorded by controller 105 as described. A SIM included in system 100 may enable a user to call brifka 195 and, e.g., based on keys pressed, control brifka 195. For example, specific key sequences received in a call may cause controller 105 to perform any required action, e.g., report data (e.g., location and the like) to server 150, activate a camera in order to take a picture of the person who opened the brifka and so on.

Tracking modules 180 may include units or modules for determining data such as location, acceleration, velocity, movement and elevation. In some embodiments, tracking modules 180 may be, or may include a single tracking module that includes all of: a GPS unit, a WiFi unit and a General Packet Radio Service (GPRS) unit. Accordingly, a single tracking module included in a brifka may determine a location of the brifka and report the location, e.g., to server 150 and/or user device 151. The advantages of a single, small factor module that includes a power source, a GPS unit and a communication unit (e.g., a GPRS or WiFi chip) may be appreciated a person having ordinary skill in the art, for example, a chip or other circuitry including a GPS unit and a communication unit as described may be installed or embedded in any container and may enable tracking the container, over a very long time period, anywhere in the world.

Tracking modules 180 may include any navigation or location systems, e.g., any one of: a Globalnaya Navigazionnaya Sputnikovaya Sistema (GLONASS); the Galileo global navigation satellite system (GNSS) or the BeiDou (or BeiDou-2) Navigation Satellite System may be included in tracking modules 180

Sensors 185 may include units or modules for determining data, parameters or aspects such as temperature (e.g., using an included thermometer), motion, pressure, humidity (e.g., using an included hygrometer) and weather (e.g., using atmospheric and/or barometric pressure sensors).

Sensors 185 may include units or modules capable of: sensing or identifying an opening of a brifka; determine that a known set of objects is indeed included in the brifka; identify or authenticate a user, e.g., based on a received fingerprint or other bio-metric data. As described, sensors 185 may include a presence sensor usable for sensing or verifying presence of items or objects in a brifka, e.g., a camera, scanner, scale or any system that may be used in order to verify or determine a presence of an object inside a brifka. Sensors 185 may include input devices, e.g., a button that, when pressed, causes controller 105 to send a message to a destination as stored in memory 120 (e.g., a telephone number or email address), e.g., a message that includes the location and identification brifka 195 or any other information.

Power source 110 may be or may include, any suitable battery and/or charging system. For example, power source 110 may be, or may include, a Nickel-cadmium or Lithium-ion (Li-ion or LIB) battery or any other small factor power source unit. Power source 110 may include a rechargeable battery and may include units, systems or ports for charging the rechargeable battery, e.g., using inductive charging technology as known in the art. Accordingly, when brifka 195 is placed on an inductive charging tray (or in an inductive charging box or container) power source 110 may be charged. In some embodiments, the container itself may be the power source. For example, a brifka or other container may be an elastic or foldable battery or other power source, e.g., a solar power cell, designed and/or manufactured as an envelope or box. A surface of a container may be, or may include, a solar cell connected to power source 110, accordingly, a container (e.g., brifka 195) may charge or re-charge power source 110.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105. For example, executable code 125 may be an application that determines and reports information such as a location, velocity and any other information or data related to a state, context, status or condition of a brifka as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Executable code 125 may include components or logic as included in an operating system as known in the art. For example, memory 120 may include a code segment (e.g., one similar to executable code 125 described herein) designed and/or configured to perform tasks involving coordination, scheduling, arbitration, supervising, controlling or otherwise managing operation of system 100, software applications and programs and/or included components or units. Accordingly, any number of software applications, routines or programs may be executed on controller 105, e.g., be an operating system or a kernel as known in the art.

Data 126 may include any information obtained or received by system 100. For example, controller 105 may process and/or record or store any data collected by sensors 185 in data 126. Data 126 may include configuration data, e.g., received from a server. Some of data 126 may be stored in a special memory (e.g., ROM) such that it may be protected, e.g., cannot be erased or modified. For example, a unique identity value (ID) or other information usable for identifying diamonds in a brifka may be stored in a ROM portion of data 126. Any other information related to goods included in a brifka may be stored in non-volatile memory that may be part of memory 120. For example, information identifying the receiver and/or sender of diamonds in a brifka may be stored in ROM of system 100, other data stored in a ROM may be a password, an encryption key and so on. For example, system 100 may include a negative-AND (NAND) Flash memory or a NOR flash memory or any other non-volatile storage technology that does not require power to retain data. Accordingly, any data stored in system 100, e.g., by a sender of diamonds, may be available at any point in time, e.g., a receiver may, upon receiving a brifka, download data from a non-volatile memory in the brifka and thus be provided with information stored thereon by the sender.

Storage system 130 may be or may include, for example, a flash memory or a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may include a non-volatile memory having the storage capacity of storage system 130. Accordingly, although shown as a separate component, storage system 130 may be embedded or included in memory 120.

Input devices 135 may be or may include a touch screen and/or pad, a scanner, a camera or any suitable input device. It will be recognized that any suitable number of input devices may be operatively connected to system 100 as shown by block 135.

Output devices 140 may include one or more displays, speakers, light-emitting diode (LED) and/or any other suitable output devices. It will be recognized that any suitable number of output devices may be operatively connected to system 100 as shown by block 140.

Any applicable input/output (I/O) devices may be connected to system 100 as shown by blocks 135 and 140. For example, I/O components included in input devices 135 and/or output devices 140 may enable to connect, to a brifka, any one of: a wired or wireless network interface card (NIC) or port; a printer port; a monitor or display port; a universal serial bus (USB) device or external hard drive.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components

Although not shown, controller 105 may be connected to some or all of the components of system 100. For example, some or all of memory 120, communication components 170, tracking devices 180 and sensors 185 may be connected to a hardware communication bus or network that enables these components to communicate as known in the art. Accordingly, controller 105 may manage and/or control components of system 100, e.g., by sending them commands or requests, provide configuration data and the like.

Network 160 may be, may comprise or may be part of a private or public IP network, or the internet, or a combination thereof. Additionally, or alternatively, network 160 may be, comprise or be part of, a GSM network. For example, network 160 may include an IP network such as the internet, a GSM related network and any equipment for bridging or otherwise connecting such networks as known in the art. In addition, network 160 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 160 are implied but not shown, e.g., access points, base stations, communication satellites, GPS satellites, routers, telephone switches, etc. It will be recognized that embodiments of the invention are not limited by the nature or type of network 160.

Identifier 190 may be a barcode or any other identification element. For example, using systems and methods as known in the art, any information related to a brifka and/or its content may be stored in identifier 190, e.g., properties of diamonds (e.g., weight, cost, flaws etc.) or any other information related to the content of the brifka, a time stamp, information related to the sender or receiver of the brifka, a unique code or identification value (e.g., ID as known in the art) and so on may all be stored on a barcode that may be, or may be included in, identifier 190. Any code or information readable by a machine may be used. As described, any information or data included in (e.g., printed on) identifier 190 as described herein may also be included, or stored, in memory 120.

and other attributes of diamonds, information enabling identifying diamonds (e.g., flaws, impurities and the like) may be stored on identifier 190. For example, any information stored in memory 120 as described herein may be also stored on identifier 190, accordingly, by downloading data from memory 120 and comparing the downloaded data to data on identifier 190, a receiver of a brifka may authenticate the brifka, e.g., ascertain the diamonds, brifka and identifier 190 are genuine, e.g., as sent by a sender. In some embodiments, identifier or label 190 may be placed on an outside of container 195, e.g., identifier 190 may be printed or glued on a brifka.

User device 151 may be any computing device adapted to receive input from a user, communicate over network 160 and provide information to a user, e.g., user device 151 may be a home computer, a laptop or a smartphone as known in the art. User device 151 may be smartphone that includes an application adapted to communicate with system 100 and/or with server 150. Accordingly, any information collected, calculated or provided by server 150 and/or system 100 may be available to a user, e.g., provided by a smartphone or computer as known in the art. For example, using a smartphone, a user may readily, quickly and easily know where brifka 195 is and/or what is happening with brifka 195.

Server 150 may be any server as known in the art, e.g., a powerful server computer operatively connected to a network and to a storage system. Server 150 may be adapted to communicate with a large number of brifkcas (each including a system 100) process information received from the brifkas, send commands to the brifkas and send or present information to users.

In some embodiments, information related to a set of brifkas may be presented to a user. For example, information related to brifkas may be graphically presented.

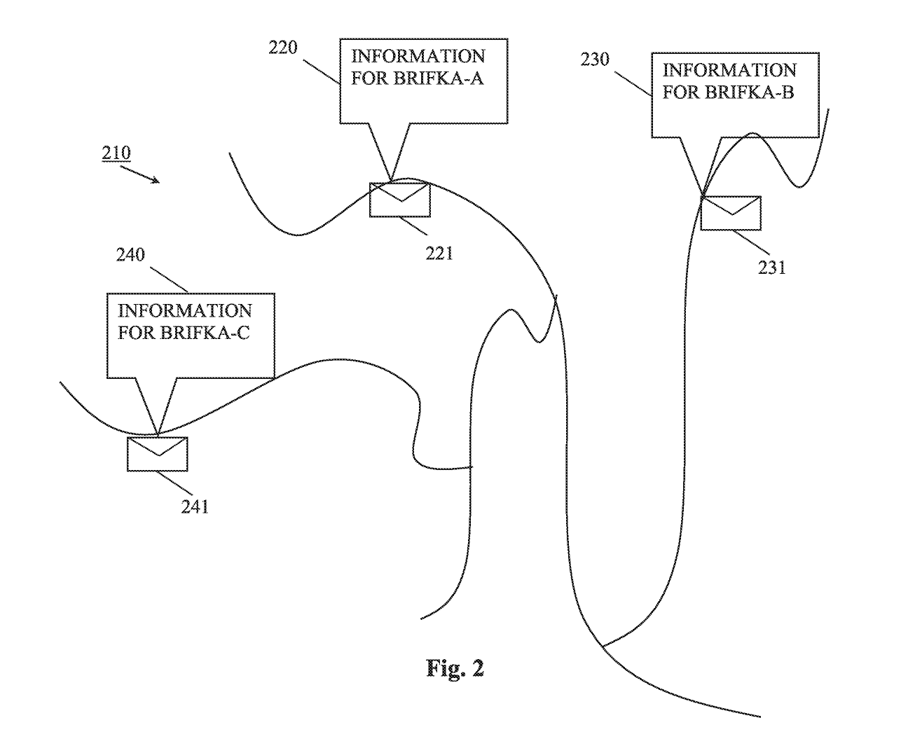

Reference is made to FIG. 2, a simplified illustration of graphical information presented to a user according to some embodiments of the present invention. As shown by FIG. 2, a server or a user device may present a map 210, a representation of brifkas as shown by blocks 221, 231 and 241 and information related to the brifkas as shown by respective texts 220, 230 and 240. For the sake of simplicity and clarity, representations of brifkas 221, 231 and 241 will be referred to herein as brifkas.

Any information received from a brifka (e.g., from a system 100 in a brifka as described) may be used, e.g., by server 150 and/or by user device 151 in order to display or present information to a user. For example, based on data collected and calculated by a system 100 included in a brifka and/or by server 150, server 150 may present, to a user, data or information including, or related to: a state, context, status or condition of a brifka, e.g., a location of a brifka, environmental data and the like. For example, server 150 may show to a user (e.g., graphically or in a list) the path or route taken by brifkas or other historical or journal information.

It will be understood that any information related to a brifka collected, determined or calculated as described herein may be presented to a user or provided to a computer or application. As referred to herein, data or information related to a state, context, status or condition of a brifka may be any data or signals sensed, calculated or otherwise obtained by sensors and other units or modules included in a brifka (e.g., by tracking components 170 and/or sensors 185). For example, data or information related to a state, context, status or condition of a brifka may include a location, acceleration, motion, velocity, movement and elevation. A state, status or condition of a brifka as referred to herein may include

A state, context, status or condition of a brifka as referred to herein may include, indicate or be based on: whether or not the brifka was opened after a specific date or time (e.g., a date and time when the brifka was shipped); whether or not a known set of objects is indeed included in the brifka and the like.

For example, text or information 220 may provide state, status or condition of brifka 221 by indicating that brifka 221 is in a specific location in Europe, was not yet opened, is now traveling at a speed of 40 miles per hour (mph) and the like, text or information 230 may indicate that brifka 231 is in a city in south America, is stationary, and the temperature around it is 28° C. and text or information 240 may indicate that brifka 241 was opened and no longer contains the set of diamonds placed in it by a sender. Various other ways of presenting information may be contemplated. For example, the color of brifkas' representations 221, 231 and 241 may be changed based on the status, condition, state or any other information or aspects of the represented brifkas. For example, if the brifka represented by icon 231 was opened the icon or image 231, shown on a display, may be green, similarly, an icon or object (e.g., icon or image 221) of a brifka that is currently moving may be blue, an icon or object (e.g., icon or image 241) of a brifka that is currently in an area known to be risky or unsafe may be black and so on.

In some embodiments, information related to brifkas may be presented in textual or other form. For example, server 150 and/or user device 151 may present, to a user, a list of all brifkas that are presently in a specific region (e.g., Europe), a list of all brifkas already opened by the receivers and so on. In other cases, a user may be provided with a filtered graphical presentation, e.g., based on a selection or request of a user, server 150 may present, on a display or monitor, only the brifkas that are in Colombia, that are currently moving, and that include diamonds worth more than $2,000. Any other filters, rules or criteria may be used.

Reporting or sending information, e.g., from brifka 195 or system 100 to server 155 and/or or user device 151, may be based on a set of rules, thresholds or criteria. For example, controller 105 may select whether or not to send the location of brifka 195 or any other information based on a state, condition or location of brifka 195. For example, based on an altitude and speed of brifka 195, known to controller 105 based on information received from tracking modules 180 and/or sensors 185 as described, controller 105 may select whether or not to send data to server 150 or otherwise communicate with server 150 and/or user device 151.

For example, when brifka 195 is flown by an aircraft, controller 105 may determine that the speed and/or altitude of brifka 195 are above a predefined threshold (e.g., as stored in memory 120) and controller 105 may stop sending location information and other information, e.g., in order to save power. When the speed or altitude of brifka 195 are back below a threshold, controller 105 may resume sending reports, e.g., to server 150. Accordingly, when airborne, a brifka may ceases sending data and, upon landing, a brifka may resume sending data as described. Any other rules or criteria may be contemplated. Any rule, threshold or criteria may be used in order to determine a frequency by which controller 105 reports or sends data related to brifka 195. For example, a rule stored in memory 120 and adhered to by controller 105 may be: may if brifka 195 is stationary send data (e.g., coordinates) every 2 minutes, if brifka 195 is moving at 2 mph then send data every 30 seconds and, if brifka 195 is moving at 50 mph then send data every 3 seconds. Complex rules may be used, e.g., if the brifka has been opened then do not send data more than once a day etc.

In another example, case, scenario or embodiment, when controller 105 determines that brifka 195 is stationary (e.g., in a post office), controller 105 may cease sending data or may send data with large time intervals. For example, when brifka 195 is in a post office, controller 105 may only send information to server 150 every 6 hours, once a day and so on, however, when brifka 195 is carried by a truck, controller 105 may send location information every 3 minutes such that a user may see and know, in real-time, what is happening with (or to) brifka 195 is, e.g., server 150 may continuously update information presented as shown by FIG. 2. For example, a location and route of a brifka may be presented in a way a car is shown by navigation applications as known in the art (e.g., Google Maps and Waze). Accordingly, power consumption of system 100 may be reduced to a minimum, e.g., by selecting a first reporting scheme when a brifka is not moving (e.g., reporting once a day) and selecting a second reporting scheme (e.g., reporting every 10 seconds) when a brifka is moving. For example, based on information from an accelerometer (or other acceleration or motion metering unit included in sensors 185) included in tracking modules 180, controller 1056 may readily determine whether or not brifka 195 is moving and may select a reporting scheme as described.

The term “real-time” (also known and referred to in the art as “realtime”, or “real time”) as referred to herein generally relates to processing or handling of events at the rate or pace that the events occur or received (possibly defined by human perception). For example, a system according to embodiments of the invention may determine aspects related to a brifka, report or send data to a server and present information to a user in real-time, e.g., within milliseconds or other very brief periods so that the whereabouts and other information related to a brifka are made available, presented or achieved virtually immediately. For example, a system may present to a user information related to a brifka, in real-time, at the rate that the conditions, state, events or other aspects related to the brifka change, occur, detected or take place.

In order to further save power or extend capacity of power source 110, controller 105 may selectively shutdown components of system 100. For example, upon determining that brifka 195 is stationary or not moving for more than a predefined period of time (e.g., 5 or 30 minutes), controller 105 may shutdown (e.g., hibernate as known in the art) some of the components of system 100 such that power consumption is reduced to a minimum. For example, controller 105 may shut down all components in system 100 other than itself and an accelerometer, and, upon being alerted from the accelerometer, that brifka 195 is moving, controller 105 may re-activate, or wakeup, components of system 100 as required. Accordingly, based on its state, status or condition a brifka may hibernate and/or wakeup.

An embodiment may track a brifka indoors. An embodiment may determine a location of a container, within a building, by sending raw geolocation information to a network geolocation service such as Skyhook and based on information received from the network geolocation service. For example, using technology and services such as provided, for example, by Skyhook, a location of a brifka inside a building may be determined, e.g., using any of GPS data, data provided by cell towers, identifiers (e.g., service set identifiers (SSIDs) or WLAN ID), names and/or IP addresses of access points and the like as known in the art. For example, based on a service and/or data provided by Skyhook, controller 105 may determine its exact location within a building as known in the art. By identifying WiFi access points and provided with their locations, system 100 may determine an altitude. For example, controller 105 may determine in what floor of a building brifka 195 is based on a distance from a known WiFi access point or hot spot. In some embodiments, controller 105 may send raw data (e.g., an SSID or geolocation data, e.g., coordinates) to server 150 and server 150 may determine a location of a brifka based on the raw data. In some embodiments, controller 105 may be adapted to determine a location or elevation of brifka 195, within a building, by sending raw geolocation information to a network geolocation service, e.g., Skyhook.

In some embodiments, system 100 may identify what stone is in a brifka. For example, sensors 185 and controller 105 may collaborate in order to determine if a stone or diamond that was inserted into the brifka (e.g., by a sender) is indeed the stone now in brifka. (e.g., determine that someone replaced an original stone with another stone. For example, an embodiment may compare characteristics of an original stone to characteristics of a stone in a brifka as described herein.

Sensors included in sensors 185 may be used in order to determine or identify any aspects related to items or objects included in a britka. For example, a scale, a light source (e.g., a light-emitting diode (LED)) and/or a receiver or an imaging device included in sensors 185 may be used in order to scan and obtain any data or information that characterizes, describes, identifies or otherwise related to diamonds inside brifka 195. For example, characteristics of diamonds placed in a brifka may be stored in data 126 as described (e.g., by the sender of the diamonds), e.g., data describing or representing any one or more of: shape, carat weight, anatomy, cut, color and/or clarity of a diamond in brifka 195 may be stored in memory 120 and may be used, by controller 105, in order to determine whether or not a specific diamond (that matches a description in memory 120) is indeed present in brifka 195.

For example, prior to sending diamonds using brifka 195, a sender may use a camera or scanner to capture data that represents a number of key features of the diamonds and may store the data representing the key features in memory 120. In other cases, a sender may receive or obtain information that characterizes objects placed in a container.

At any point in time (e.g., continuously, periodically and/or repeatedly, every hour, every day etc.), controller 105 may activate a scanner, camera or other device included in sensors 185, receive characteristics (e.g., key features as described) of the diamonds from the imaging or other device, compare the received characteristics to the stored characteristics to thereby determine whether or not the diamonds in brifka 195 are indeed those placed in brifka 195 by the sender. In an embodiment, a scale may be included in system 100 and controller may continuously, periodically and/or repeatedly check the weight of objects in brifka 195. Of course, in some cases, e.g., when the brifka is placed such that the diamonds are below a scale included in system 100, the correct weight cannot be identified or determined, however, by checking the weight of diamonds in brifka 195 continuously, periodically and/or repeatedly and/or after every time brifka 195 moves or changes its orientation in space (e.g., as indicated by a sensor as described), controller 105 may record or mark the maximal measured weight as the actual or correct weight of the diamonds and, if over time, controller 105 identifies a decrease in the maximal measured weight, controller 105 may determine that the content of brifka 195 has changed. Controller 105 may compare a maximal measured weight to a weight stored in memory 120 and thus determine whether or not the original diamonds (e.g., as placed in brifka 195 by a sender) are present inside brifka 195.

Accordingly, an embodiment may verify the content of a brifka, for example and as described, an embodiment may verify or ascertain that the diamonds in a brifka match the specification as stored in a ROM in the brifka. Of course, if diamonds are removed from a brifka then a verification of the content of the brifka as described will fail, e.g., if the diamonds are removed from the brifka then controller 105 may determine the content in the brifka does not match the characteristics stored in memory 120. Accordingly, an embodiment may report whether or not specific items are present in a container.

Controller 105 may report to server 150 (e.g., continuously, periodically and/or repeatedly) whether or not the content in a brifka is verified. Accordingly, a user may know exactly when and where diamonds were removed from (or replaced in) a brifka. As described, reporting to server 150 may be based on a state, status, context or condition, for example, after determining brifka 195 is empty, controller 105 may lower the reporting frequency to a minimum.

Sensors included in sensors 185 may be used in order to determine any event, condition or aspect related to brifka 195. For example, magnetic, electric or other sensors used in alarm systems as known in the art may be used in order to determine or identify an opening and/or closing of brifka 195. For example, magnetic tapes or proximity sensors properly attached to brifka 195 may enable identifying an opening and/or closing of brifka 195.

Controller 105 may report, e.g., to server 150 and/or user device 151 upon determining, detecting or identifying that brifka 195 was opened and/or closed. Controller 105 may record the time brifka 195 was opened and/or closed, the place or location brifka 195 was opened and/or closed and/or any other data available to controller 105 as described. Accordingly, an embodiment may enable a user to known exactly when, where and how many times a brifka was opened and/or closed.

Communication between system 100 and any entity may be encrypted, e.g., as known in the art. For example, controller 105 may use an encryption key stored in memory 120 in order to encrypt out going messages or data and decrypt incoming messages or data as known in the art. Accordingly, communication with a brifka may be secured.

Any event, condition, state or other aspect may cause controller 105 to autonomously or automatically send a message to server 150 and/or to user device 151. For example, based on input from a sensor indicating that brifka 195 was opened, is moving or indicating stones were removed from brifka 195, controller 105 may send a message to server 150.

As described, a set of rules or criteria may be used, by controller 105, in order to determine when and/or what to report to server 150. For example, a geographic location or area may be defined as “high risk” or “low risk” and controller 105 may report the location (or other aspects) of brifka 195 more often (e.g., every 10 minutes) when brifka 195 is in a “high risk” area and report with a lower frequency (e.g., once a day) when brifka 195 is in a “low risk” area. For example, “high risk” and “low risk” areas may be defined by a user, provided to server 150 and server 150 may send area risk definitions to controller 105. Controller 105 may store, in memory 120, definitions or identifications of “high risk” and “low risk” areas and, based on its location, determine whether brifka 195 is in a “high risk” or “low risk” area and report accordingly as described.

In some embodiments, controller 105 may continuously, periodically and/or repeatedly cause a module included in communication components 170 to scan for open or freely available networks. For example, as known in the art, open, free for using WiFi networks are available in many locations, accordingly, by scanning for available networks, controller 105 may detect a network and use it in order to communicate with server 150. Accordingly, an embodiment may automatically and autonomously find, and connect to, a network and communicate with a server or user over the network it connected to. For example, system 100 may, when traveling anywhere in the world, automatically and/or autonomously find and connect to a WiFi network and use the WiFi network report to server 150 as described. The advantages of a container that automatically and/or autonomously finds a network and establishes a connection with a server may be well appreciated by a person having ordinary skill in the art.

An embodiment may include a user interface system, device or component. For example, brifka 195 may include a display (e.g., liquid crystal display LCD) and controller 105 may present, on the display, any data related to brifka 195. For example, the route taken by brifka 195, information related to diamonds in the brifka and so on may be presented on a display installed in or on brifka 195. Any information or data obtained, calculated, determined or available to server 150, system 100 and user device 151 as described herein may be presented on a display attached to brifka 195. In some embodiments, server 150 and/or user device 151 may send information to controller 105 and controller 105 may present the information on a display of brifka 195. Accordingly, a sender may, in real-time, present information to a receiver, on a display attached to a brifka held by the receiver.

Brifka 195 may include an input unit, e.g., a keypad, a scanner and the like. Controller 105 may be adapted to perform, based on data received from the input unit, operations such as, but not limited to, verifying or authenticating a user, authorizing opening brifka 195 and sending a message to server 150 and/or to user device 151. For example, based on a password punched into a keypad, controller 105 may determine that the receiver is allowed (or authorized) to open brifka 195 and therefore may refrain from sending an alarm to server 150 when brifka 195 is opened. However, if the password provided is wrong, controller 105 may send a message to server 150 informing an unauthorized attempt to open brifka 195. Other means for authenticating a user may be used, e.g., an input unit may be adapted to obtain a fingerprint, an eye retina scan or other biometric parameter value and so on.

For example, controller 105 may be adapted to receive a biometric parameter value and perform an action based on relating the received biometric value to a biometric parameter value stored in memory 120. For example, controller 105 may compare a fingerprint received by an input unit as described to a fingerprint stored in memory 120 and, if the fingerprints do not match, controller 105 may send an alarm message to server 150 informing an attempt to open brifka 195 by an unknown, or unexpected person. For example, an intended receiver may send, to a sender, a fingerprint or other bio-metric value or parameter, the sender may store the bio-metric value in memory 120 and thus, the receiver may be identified as described. In other cases, e.g., when a password is used as described, the sender may provide the receiver with the password.

Information may be presented on a display included in brifka 195 based on a verification or authentication of a user. For example, if a correct password is entered as described, controller 105 may present (possibly sensitive) information such as the price of diamonds, details related to the sender and so on. Accordingly, an embodiment may provide secured or sensitive information to a known or authenticated user and prevent other users from obtaining the information. It will be noted that, as described, any information may be encrypted. For example, any information stored in memory 120 may be encrypted such that even if memory 120 is removed from brifka 195, the information thereon may be of no use to an unauthorized person.

In some embodiments, a group or set of containers may be defined and an embodiment may determine a state, context, status, condition or other aspect related to the group and may perform one or more actions based on the state, context, status, condition or other aspect related to the group or set. A set of rules, thresholds or criteria may be associated with a group or set of containers and an action performed may be based on the rules, thresholds or criteria. Metadata may be associated with a group of containers, for example, a sender, receiver, route and the like may be associated with a group or set of containers.

For example, a user may wish to send a group or set of brifkas to a receiver and may further want the group to be sent together. In such exemplary case, the user may define a group that includes the brifkas and associate one or more rules, thresholds or criteria with the group. For example, a barcode on a brifka may include an identification of the brifka, accordingly, a sender may scan the barcodes of a group of brifkas and upload, to server 150, the identifications of the brifkas in a group. The user may further provide server 150 with any rules, thresholds or criteria for the group of brifkas.

As described, server 150 may receive information from any number of brifkas, e.g., server 150 may receive the locations of all brifkas in a group. Accordingly, a group of brifkas may be treated, by server 150, as a unit or entity and any rules, thresholds or criteria may be applied, by server 150, to the group of brifkas. For example, server 150 may track a group of brifkas as described and may generate an alarm if at least one brifka that belongs to the group is separated from the group, e.g., the brifka is at a distance that is above a threshold from at least one other brifka in the group. Accordingly, an embodiment may guard a group of brifkas by ascertaining that members of the group stay together and inform or alarm a user if a member of the group is separated from the group.

For example, a rule or threshold may dictate that brifkas in a group must stay together, e.g., at a distance of no more than 50 meters from each other. Accordingly, if one brifka in a group of brifkas is carried away from the group, server 150 may determine that a threshold was breached (e.g., by identifying that the location of the brifka is distant from the location of other brifkas in the group) and may call, or send an alarm message to, a list of contacts, e.g., a list of electronic mails (emails) addresses or telephone numbers associated with the group (e.g., the sender and receiver of the set of brifkas). Accordingly, for example, if a brifka in a group is stolen and carried away from the group, an alarm (e.g., a text or Short Message Service (SMS) message) may be sent to an owner or other interested party.

In some embodiments, brifkas may communicate with each other. For example, a set or group of brifkas may be configured to communicate and verify that they are in close proximity. The set of brifkcas may be further configured to send an alarm if a rule or threshold is breached or broken. For example, a controller included in a first container (e.g., in BRIFKA-A) may be adapted to communicate with a controller in a second container (e.g., in BRIFKA-B); determine a distance of the second container from the first container (e.g., determine the distance between BRIFKA-A and BRIFKA-B); and if the distance is above a threshold then report to a server.

For example, a first and second brifkas may be configured to continuously, periodically and/or repeatedly exchange a beacon or other message (e.g., a message including their location), e.g., using PAN communication as described. The first and second brifkas may be further configured to raise an alarm if they fail to communicate over a predefined timer period (e.g., 1 minute) or if the distance between them is above a threshold. For example, knowing its location and provided with the location of another brifka as described, a controller in a brifka may determine whether or not the distance to the other brifka is above a threshold included in memory 120.

Accordingly, if the first and second brifkas are separated, the brifkas may raise an alarm, e.g., in the form of an alarm message sent to a sender or receiver as described. Accordingly, in some embodiments, a group of brifkas may autonomously, even without involvement of a server, observer rules or criteria, e.g., a set of brifkas may continuously, periodically and/or repeatedly verify that all elements in the set are at the same place, traveling at the same speed and the like.

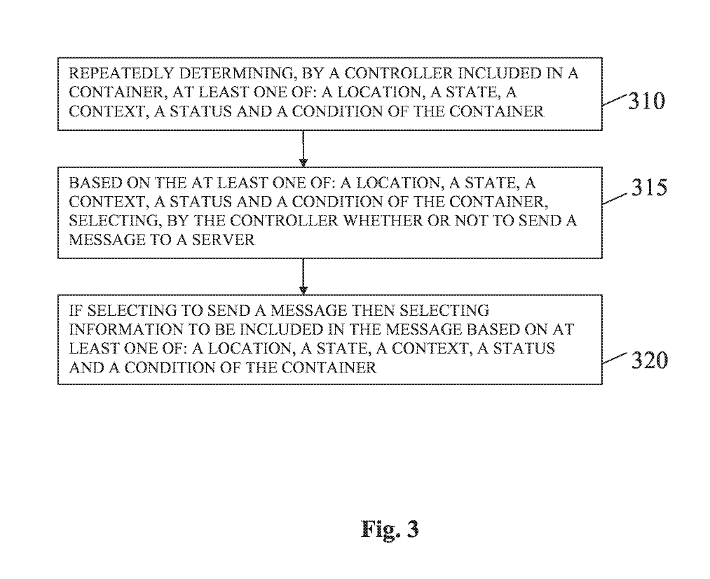

Reference is made to FIG. 3, a flowchart of a method according to illustrative embodiments of the present invention. As shown by block 310, a controller may repeatedly, continuously or iteratively determine at least one of a location, a state, a context, a status and a condition of the container. For example, controller 105 may repeatedly determine a location, a state, a context, a status and a condition of the container, e.g., controller 105 may determine, based on input from a GPS unit, the location of brifka 195 and controller 105 may further determine a state, context or condition of brifka 195, e.g., whether or not brifka 195 was opened, whether or not brifka 195 is empty (and/or contains specific, known diamonds) etc.

As shown by block 315, a method may include selecting whether or not to send a message to a server based on at least one of: a location, a state, a context, a status and a condition of a container. For example, controller 105 may select to send a message to server 150 based on a location of brifka 195. For example, memory 120 may include a set of predefined locations (e.g., entered by a sender) and when controller 105 identifies that brifka 195 is in one of the predefined locations, controller 105 may send a message to server 150 informing server 150 that brifka 195 has reached a specified or predefined location. In another example, controller 105 may select to send a message to server 150 if a state of brifka 195 changes, e.g., when brifka 195 is opened, emptied etc. In yet another example, controller 105 may select whether or not to send messages to server 150 based on whether or not brifka 195 is moving, travelling at a speed above a threshold and so on.

As shown by block 320, a method may include, if selecting to send a message, then selecting information to be included in the message based on the at least one of: a location, a state, a context, a status and a condition of the container. For example, controller 105 send, to server 150, different messages with different content in different times and/or for different states or conditions of brifka 195 as described. For example, controller 105 may select to send, to server 150, a first message that includes a first content when brifka 195 is stationary or not moving, controller 105 may select to send, to server 150, a second, different message that includes a second, different content, when brifka 195 is mobile and further select to send a third message when brifka 195 is opened. Accordingly, selecting whether or not to send a message and/or selecting content of a message may be based on any of: a location, a state, a context, a status and a condition of brifka 195 as shown by block 320.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system comprising:
a shippable container including:
a memory;
a communication unit;
a location unit adapted to determine a location of the container;
a power source;
and
a controller configured to:
use the communication unit to report a location of the container to a server.

2. The system of claim 1, wherein the shippable container is a brifka envelope used to ship diamonds.

3. The system of claim 1, wherein the controller is adapted to determine a location of the container, within a building, by sending raw geolocation information to a network geolocation service.

4. The system of claim 1, wherein the container includes a display and wherein the controller is adapted to present, on the display, information related to the container.

5. The system of claim 1, wherein the container includes an input unit and wherein the controller is adapted to send a message to a server based on data received from the input unit.

6. The system of claim 1, wherein the controller is adapted to autonomously use the communication unit to connect to a network and send, over the network, a message to the server.

7. The system of claim 1, wherein the container includes sensors for sensing at least one of: a temperature, a motion, a pressure, a humidity, an acceleration, a velocity, an opening of the container and a presence of specific objects in the container and wherein the controller is adapted to autonomously send a message to the server based on input from the sensors.

8. The system of claim 1, wherein a controller included in a first container is adapted to:
communicate with a controller in a second container,
determine a distance of the second container from the first container, and
if the distance is above a threshold then report to a server.

9. The system of claim 1, wherein the server is adapted to track a group of containers and generate an alarm if at least one container is separated from the group.

10. The system of claim 1, wherein the controller is adapted to detect and report at least one of: an opening of the container and a replacement of an object in the container.

11. The system of claim 1, wherein the controller is adapted to shutdown or activate a component included in the container based on at least one of: a state, a context, a status and a condition of the container.

12. The system of claim 1, wherein the controller is adapted to send information to the server based on at least one of: a state, a context, a status and a condition of the container.

13. A method comprising:
repeatedly determining, by a controller included in a shippable container, at least one of: a location, a state, a context, a status and a condition of the container,
based on the at least one of: a location, a state, a context, a status and a condition of the container, selecting, by the controller whether or not to send a message to a server; and
if selecting to send a message then selecting, by the controller and based on the at least one of: a location, a state, a context, a status and a condition of the container, information to be included in the message.

14. The method of claim 13, wherein the shippable container is a brifka envelope used to ship diamonds.

15. The method of claim 13, comprising determining a location of the container, within a building, by sending raw geolocation information to a network geolocation service.

16. The method of claim 13, comprising displaying information related to the container on a display installed on the container.

17. The method of claim 13, comprising sending a message to a server based on data received from an input unit included in the container.

18. The method of claim 13, comprising autonomously using a communication unit to connect to a network and sending, over the network, a message to a server.

19. The method of claim 13, comprising tracking a group of containers and generating an alarm if at least one container is separated from the group.

20. The method of claim 13, comprising:
determining a distance of a first container from a second container, and
if the distance is above a threshold then reporting to a server.
